(19) United States
(12) Patent Application Publication
(10) Pub. No.: US 2008/0133326 A1
(43) Pub. Date: Jun. 5, 2008

(54) System and Method For Collaborative Event Defining, Voting and Funding

(76) Inventors: Rios Joao Nelso Goncalves, Belo Horizonte (BR); Ricardo Goncalves Rios, Belo Horizonte (BR); Hobaika Macelo Bechara Souza, Belo Horizonte (BR); Frederico Valente Souza, Belo Horizonte (BR); Ricardo Capucio Borges, Belo Horizonte (BR)

Correspondence Address: DAVID A. GUERRA;INTERNATIONAL PATENT GROUP, LLC, 2025 17TH AVENUE N.W., CALGARY, AB, T2M 0S7, omitted

(21) Appl. No.: 11/814,829

(22) PCT Filed: Feb. 9, 2006
(86) PCT No.: PCT/BR06/00048

§ 371 Date: Jul. 26, 2007

(30) Foreign Application Priority Data
Feb. 11, 2005 (BR) PI 0500426-8

(51) Int. Cl. G06F 17/30

(52) U.S. Cl. 705/10

(57) ABSTRACT

System and method for collaborative defining of, voting on, and funding of events. An administrator sets up a system (1) which allows users to first define voting options (2,3) and then to vote on and donate for an option (4,5). As soon as the necessary funds for carrying out an option are available, the voting process is terminated and users are informed of the results (6, 7). Users interact with the system through different communication channels, like POTS (plain old telephone service), IM (instant messaging), WWW (world-wide web), and mobile devices.

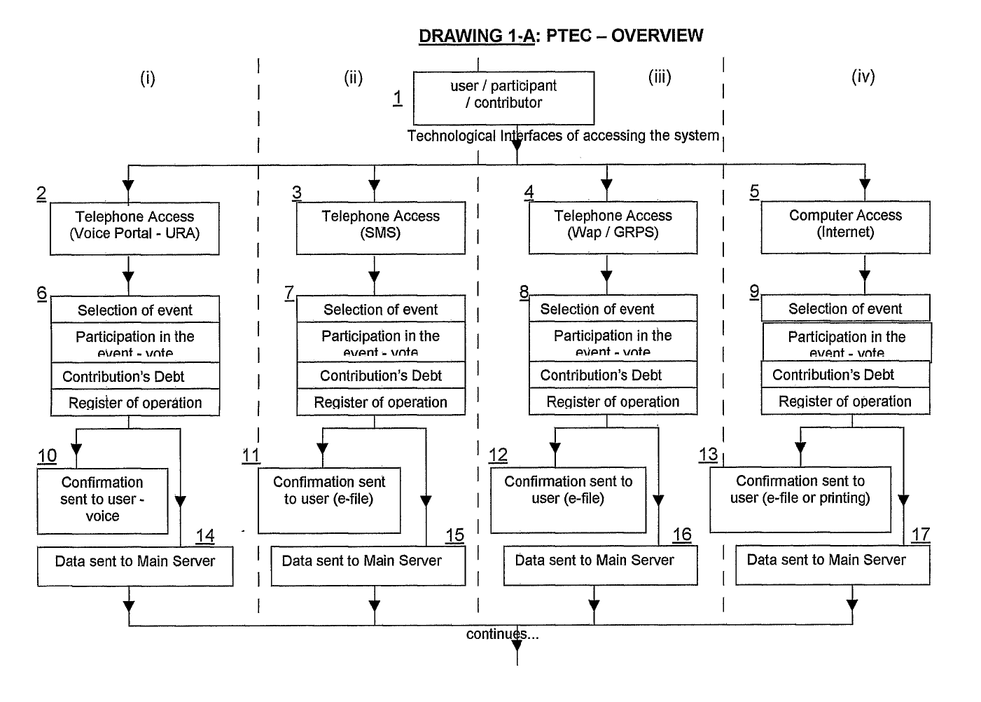

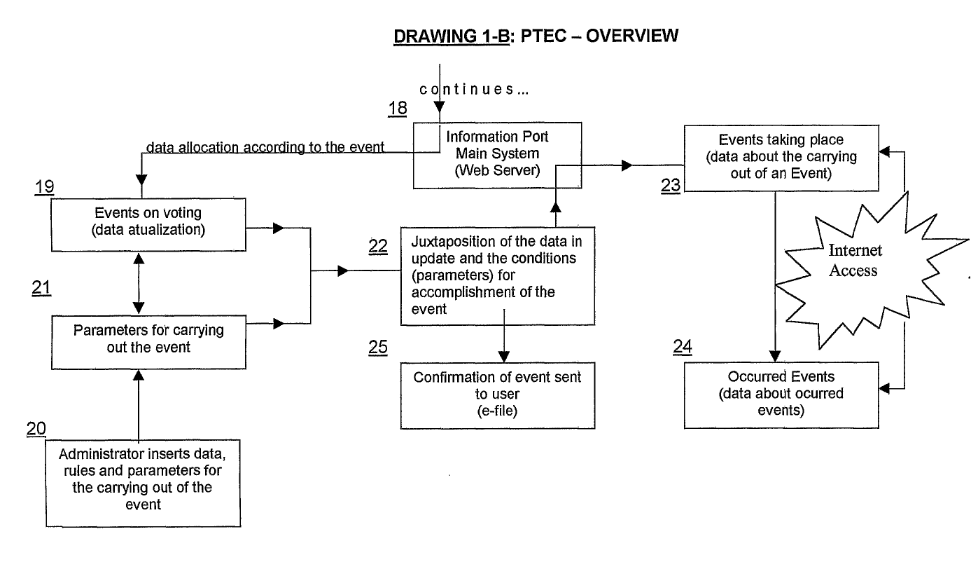

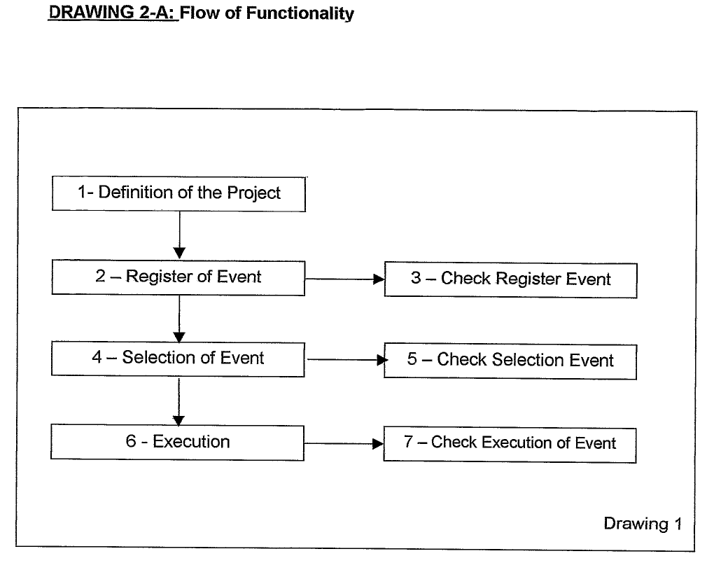

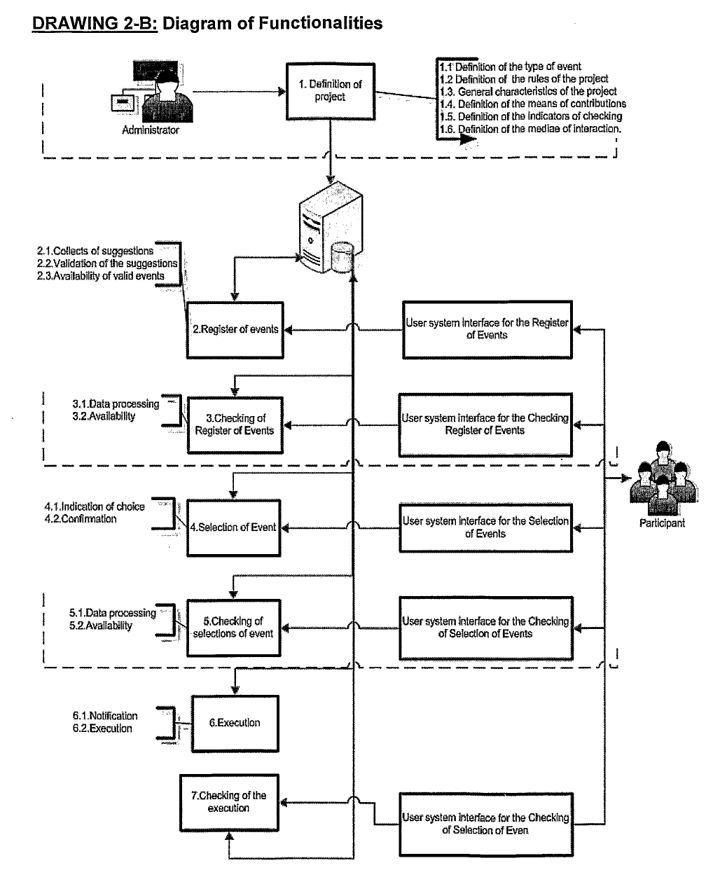

### CROSS-REFERENCE TO RELATED APPLICATIONS

This application is an U.S. national phase application under 35 U.S.C. §371 based upon co-pending International Application No. PCT/BR2006/000048 filed on Feb. 9, 2006. Additionally, this U.S. national phase application claims the benefit of priority of co-pending International Application No. PCT/BR2006/000048 filed on Feb. 9, 2006 and Brazilian Application No. PI 0500426-8 filed on Feb. 11, 2005. The entire disclosures of the prior applications are incorporated herein by reference. The international application was published on Aug. 17, 2006 under Publication No. WO 2006/084344 A3.

### BACKGROUND OF THE INVENTION

1. Field of the Invention

This patent refers to an innovatory process characterized by an electronic system, which makes possible the remote creation and carrying of one or more events, by means of the individual contribution and democratic, automatic and dynamic election of these events, carried out by countless participants interested in the attainment of these events. Through a technological process materialized in an electronic system of technical solutions of information technology and telecommunications, the PTEC provides information and means for receiving of remotely supplied data which are organized such as to make possible the participation of a person in the creation and carrying out of a given event. It suits basically the possibility of which a person, could remotely contribute and vote for the happening of a future event of his interest, either determined or yet to be determined.

2. Description of the Prior Art

At present, there are no notices of processes or suitable electronic or analogical systems that make possible the creation and carrying out of events in the presented fashion. There are systems of electronic vote aimed at the individuals' participation in the definition of an event pre established where the participants act as mere opinion givers in the definition of the presented proposition. Therefore, there is never the participation of an individual in the consecution of the event or in how it will happen. In other words, the decision power in the consecution of the event lies the hands of his producer without the interference of the individuals who contributed or voted for its happening. As an example of the existent technique, we might list poll queries such as: Which was the best player of this match? Which participant do you want to eliminate? Which show do you want to watch next time? Which concert do you want to watch in Brazil? So it is clear that the event was already planned and guaranteed, and that the individual can only choose one out of the options given. There is no personal feedback of the contribution or straight influence in the occurring or not of the event.

### SUMMARY OF THE INVENTION

As an innovative solution to the problem, we present PTEC, a totally dynamic and automated system where the individuals have the possibility to add efforts up for the creation and carrying out of future events chosen by means of an automated process of vote, contributing directly to its occurring and being personally rewarded for his participation. Thus, each event is arranged based on groups of interest formed to contribute not only with its opinion on how the event will be set, but also contribute on the funding and financial viability of the event. As a result, personal interest will arise in each and every participant. They will have free access to the information on their respective group of interest, and the possibility to check on the evolution of the contributions and what's the most popular way to set up the event up to that moment. As soon as the contributive limit was reached for the setting up of the event the contributing participants will receive a notice indicating which was the winning alternative and what will be carried out. Additionally, each person that contributed for the occurring of the event will be granted the right to participate of taking place in it, either as merely attending to it, or as obtaining a specific and individual benefit resultant from the force of his contribution.

The main difference between the PTEC and the already existing systems relies in the fact that, in the former, the contributor is a co-producer of the event and not a mere collaborator.

A classic example of the application of the hereby required Patent is seen towards the organization of a group of individuals interested in the hiring by a team of a famous soccer player. Thus, each participant will be presented to list of possibilities and will vote for the player of his preference contributing, when of the vote, with a donation to a fund for the acquisition of the rights of the athlete. When the fund formed by the contributors reaches the necessary amount for hiring of the athlete, the system will check who was the most wanted professional, shut the contribution possibilities and release a notice to each one of the participants indicating the carrying out of the event materialized by the hiring of the sportsman. The whole process is carried out remotely through systems of information technology and telecommunications (e-mail, Internet telephone, instant messages, etc.) whose sent and received data they are joined in a central system with the objective to collect information and make them available in automatic routines for the carrying out of the events proposed.

### BRIEF DESCRIPTION OF THE DRAWINGS

The invention will be better understood and objects other than those set forth above will become apparent when consideration is given to the following detailed description thereof. Such description makes reference to the annexed drawings wherein:

DRAWING 1A is a schematic diagram showing how the system works through the four initially predicted processes of carrying it out constructed in accordance with the principles of the present invention.

DRAWING 1B is a schematic diagram showing how the system works through the four initially predicted processes of carrying it out constructed in accordance with the principles of the present invention.

DRAWING 2A is a schematic flow diagram of the tools and works and the organization of these modules of the present invention.

DRAWING 2B is a schematic flow diagram of the entire flow operation of the present invention.

The same reference numerals refer to the same parts throughout the various figures.

### DESCRIPTION OF THE PREFERRED EMBODIMENT

Before we discuss the technological queries of the process, it is important to highlight that the whole process, system, methods, programs and other resources hereby described and which together compose the system and method for collaborative event defining, voting, and funding are not and cannot be limited by any technology in particular such as computational processes, equipment, programming language, protocol, etc. Also, it must be clear that, though the Internet and other and technologies of the Telecommunications are hereby used as chosen technologies for the trafficking of data and information for the system and method for collaborative event defining, voting, and funding is, other technological processes will be able to be implanted by the advancement and dissemination of new technologies. Nevertheless, regardless of the applied technology, there must be kept the innovatory idea behind the system and method for collaborative event defining, voting, and funding.

As to the technicalities, the system and method for collaborative event defining, voting, and funding is carried out by means of the resource allocation of the telematics—specially related to the Internet—and of the telecommunications—specially related to voice portals.

As a result of the use of the alluded technological resources, the whole process can be carried out in at least four different slopes that aim to the same goal: to make possible the creation and the carrying out of events remotely by means of the contribution of several individuals with convergent interests. The four referred processes consist in (i) PTEC Telephone, based on the usage of the telecommunication resources (fixed or mobile telephony); (ii) PTEC IM1 with the use of instant messages (cellular, Internet and other technologies); (iii) PTEC Movable (accessed through mobile Internet, cellular telephones and other technologies); and (iv) PTEC Web, with the resource use of the Internet (accessed straightly by the users through a system of electronic commerce or from accredited dealers).

DRAWING 1 (1A+1B) represents a macro illustration of the system and method for collaborative event defining, voting, and funding, showing how the system works through the four initially predicted processes of carrying it out. The arrows indicate the flows of data and traffic of information. Detailing the drawing, each of the stages is represented by a number and its respective description. Let's see. PTEC TELEPHONE (i): (1) The user/contributor accesses the system through fixed or mobile telephone. (2) In this mode, the tool of access is a telephone and the commands to take part of the system and method for collaborative event defining, voting, and funding are given through a Voice Portal—using a technology called URA—Unity of Audible Answer—where the user pushes the numbers to participate in the system and method for collaborative event defining, voting, and funding. (6) Thus, the user first selects the number of the event in which he wants to take part (ex: 22—Hiring of soccer player by Team X); then, he pushes the number of the player for whom he intends to vote (Ex: 09—John Dough); he votes according to his interest (EX: hire athlete); he the confirmation message (Ex: “Thank you for calling. The cost of this call is $ XX,XX+taxes. You chose to contribute in the hiring of John Dough by Team X. Check the progress of his event through our website”); at this moment URA System accounts the corresponding debt to the donated value that will be billed to the contributor; the whole operation is registered generating an ID number which will also be available in the bill. (10) At the end of the operation URA system will send out a notice to the contributor (Ex: “Your donation was successful. Your ID number is XXXXX”). (14) The system sends the data of the operation for the Main Server. PTEC SMS (ii): (3) This option takes by mobile telephony complied with sending and receiving instant messages technology (cell phones, palms). The commands to take part in the system and method for collaborative event defining, voting, and funding must be given through the sending of instant text sms. (7) Thus, the user types the text to match the identification of the number of the event in which he wants to take part (ex: 22—Hiring of soccer player by Team X); then he votes on the number correspondent to the player of his preference (Ex: 09—John Dough) therefore voting through sms (Ex: Team X. John Dough. Hiring); he receives a system notice (Ex: “message successfully sent”); at this moment the Ml System accounts the corresponding debt to the donated value which will be billed to the contributor; the whole operation is registered generating an ID number. (11) At the end of the operation the system sends a confirmation message (Ex: “Your participation was successful. Your ID number is XXXXXX”). (15) The system sends the data of the operation to the Main Server. PTEC Mobile (iii): (4) This option of access uses mobile telephony technology integrated with the access of Internet or telecommunications. The commands to take part in the system and method for collaborative event defining, voting, and funding are given through surfing through the alluded technologies. (8) Thus, the user accesses the surfing portal and selects the event in which he wishes to take part (ex: 22—Hiring of soccer player by Team X); then he votes on the number corresponding to the player of his choice (Ex: 09—John Dough); votes by accessing the option (Ex: hire); he then receives a system's notice (Ex: “successful operation”); then, the contributor inserts his credit card billing information for immediate payment. The system accounts the corresponding donated value; register the payment and gives out an ID number, (12) At the end of the operation the system sends a message of confirmation to the contributor (Ex: “Your participation was successful. Your ID number is XXXXX”). (15) The system sends the data of the operation to the Main Server. PTEC Web (iv): (5) In this mode the participants can contribute through a computer logged on the Internet permitting them to access directly (through system of electronic commerce) or by means of the payment at accredited dealers (ex: lottery homes, movie theaters, etc.) to participate of the system and method for collaborative event defining, voting, and funding through Web surfing. (9) Thus, the user accesses the site on the Internet and selects the event in which he wants to take part (ex: 22—Hiring of soccer player by Team X); then he accesses the number of the corresponding player to his vote (Ex: 09—John Dough); and votes accessing his option (Ex: hire); he receives the notice of the system (Ex: “successful operation”); at this moment the user inserts the data of the number of the credit card or bank account and after the payment the System accounts the corresponding contribution to the donation fund; upon the confirmation of the payment, the operation is registered producing an ID number. (13) At the end of the operation the website sends a message of confirmation (Ex: “Your participation was successful. Your ID number is XXXXX”). (17) The system sends the data of the operation for the Main Server. (18) The Web Server collects the information sent by all the means and allocates it according to the respective event. (19) The data regarding of the events in vote (voted options/collected amounts, are constantly accounted for and made available together with (20) the data referring to the parameters established for occurring of the event. (21) These data are inserted by the System's manager inside the system and method for collaborative event defining, voting, and funding. (22) When the votes reach the defined limits for the occurrence of the event the system shuts the process of contribution/vote. (23) Then, the data of the event are transferred to section Events in Progress, in order to the set up of the event according to the parameters chosen. Such data are available in the Internet for the contributors/users. (25) Meanwhile, the System sends a message to all the participants announcing that the event will be carried out and informing the options of attendance and other important information regarding the event. (24) As soon as the event is over, its whole process and the general data are made available to the public in the section “Concluded Events”.

DESCRIPTION OF PTECs ALGORITHM: As said before, the system and method for collaborative event defining, voting, and funding consists of a process for creation and carrying out of events with the contribution of his participants. The events hereby referred to are any events, actions or projects that should come into execution in the future. In the system and method for collaborative event defining, voting, and funding the participants indicate what the possible events are and select, among these, which will take place. In addition to this, the participants contribute effectively to the carrying out of the event. Here, the system will be described from a functional description, beginning with a macro description of its tools and works and later, refining, detailing, each of them. The system and method for collaborative event defining, voting, and funding can be divided into 7 (seven) different functional basic modules: 1) Definition of the project; 2) Register of events; 3) Checking of register of event; 4) Selection of event; 5) Checking of selection of event; 6) Execution; 7) Checking of execution. The description of the tools and works and the organization of these modules can be visualized in DRAWING 2. Next, each one of these modules will be detailed.

DRAWING #2: (1) Definition of the Project. In this module all the informations, rules and characteristics of the project will be defined by the administrators of the system. These definitions straightly affect the functioning of the subsequent modules, the participants and the events themselves. (2) Register of Events. In this module the events will be added for vote and execution. This register consists in obtaining suggestions of the participants, validating them and finally making them available for vote and subsequent execution. (3) Checking of Register of Event. During the register of events the participants check through this module which are the new suggestions, which ones were validated, how many events will be available. These information are available in accordance with the interfaces that were informed previously. (4) Selection of event. After the register of the events the system will release a list wherein, for each type there will be several event options. The participant will vote for which of the events of a determined type of event he wants to see carried out. The vote must be carried out by the participant interacting in one of the interaction media defined for the selection of the event pursuant to the rules of project previously stipulated. (5) Checking of Selection of Event. Like the Checking of Register of Event, it allows the participants to follow the progress of the votes of the system. (6) Execution. The execution module is designed to execute the events selected in the selection module according to the rules stipulated in the definition of the project. The execution is divided in two sub modules. (7) Checking of Execution. The module of checking of execution is designed to the contributor to follow the events in execution.

After analyzing briefly the generic tools and works of the system, DRAWING 2-B shows in whole operational flow of the system and method for collaborative event defining, voting, and funding. The diagram represented by DRAWING 2-B shows the interaction of the system with its several participants, as well as the answers of the system to these participants as follows: (1) Definition of the Project. This module is subdivided in: (1.1.) definition of the type of event; (1.2) Definition of the rules of the project; (1.3) general characteristics of the project; (1.4) Definition of the forms of contribution; (1.5) Definition of the indicators of checking; and (1.6) Definition of the media of interaction. (1.1) The definition of the type of event is a description of how the events that will be selected in the project should be. In other words, it specifies the characteristics and rules that an event should contemplate in order to be used by the system and method for collaborative event defining, voting, and funding. The project will be able to contain more than a type of event. The characteristics and rules must be specified for each type of event. All types of events will implicate in an execution. (1.2) Definition of the rules of the project are standards of functioning which govern the system. They apply to a type of event in one or more modules. Thus, these definitions are used to show how the participants will interact with the system, and also to restrict the participation of a contributor. These definitions are also important to describe what will happen in case the execution of a certain event turns out to b& impossible, unforeseen circumstances with participants, etc. (1.3). The general characteristics of the project are composed of information needed to identity the project, such as: name, logo, slogan, etc. These information must be used in all the modules of the available media that enables the use of the system and method for collaborative event defining, voting, and funding. (1.6) Definition of the media of interaction are interfaces that allow that the participants to interact with the system. They must be defined by module taking into account the definitions of the type of event. All the modules must have at least one media of interaction. (1.4) Definition of the forms of contribution are all the forms of gathering resources herein described. The forms of contribution must be attributed to each module with the indication of the values. The forms of the collection of funds must also be described, including with the cost of implementation of each one. (1.5) Definition of the indicators of checking are indicators that must be defined for each type of event and for each module, which includes a politic of access. All the checking will be based on these indicators. The checking of each module will happen through these indicators. Regarding the Register of Events (2), this module is subdivided in three stages. In (2.1) Collects of Suggestions the participants suggest which events must be executed through the predefined media taking into account the definitions of type of event. In (2,2) Validation of the Suggestions each suggestion will have to be validated according to the definition of type of event as well as the rules of the project. As soon as a suggestion is validated the contribution will be collected so that this suggestion becomes a susceptible event of being executed. The collection is set in the definition of the forms of contribution. So, in (2.3) Availability of Valid Events the valid suggestions are called events that may be carried out. At this point the participants are informed, through the defined-media, of the list of events that can be chosen. (3) Checking of Register of Event, is subdivided in two sub modules. The first is (3.1) Data processing that consists in working the data obtained in the register of events so that they are organized in accordance with the indicators that were described in the sub module of definition of indicators of checking. This processing must take into account the rules of the project. After, in the stage of Availability (3.2) all the processed indicators are made available so that the participants can follow the progresses of the register of event with a premiere of the events cost being available for selection. The process of (4) Selection of Event is divided in two phases. In the (4.1) Indication of Choice the participant must indicate precisely and concisely which of the events of a determined type of event he wants to contribute to and the (4.2) Confirmation, in which after choosing the event of his choice the system must ask for the confirmation of the choice and only then account for his contribution. Once confirmed, the system gives out to the participant a receipt of vote, the usefulness of his vote is defined in accordance with the rules of the project. The Checking of Selection of Event (5) is also divided in two sub modules. (5.1) Processing of the data consists in working the data obtained in the selection of events and organize them in accordance with the indicators that were described in the sub module of definition of indicators of attendance. Besides this processing must take the rules of the project into account. In (5.2) availability all the processed data are published for the participants so that they can accompany the progress of the votes through his previously defined media. Equally, the (6) Execution implicates in two stages. They are: (6.1) Notification, where all the participants of the system and method for collaborative event defining, voting, and funding must be notified of the execution of the event through their defined media of interaction and the (6.2) Execution that consists in really carrying out the selected event(s). Finally, in (7) Checking of Execution, through the definite media, there is a step by step demonstration of the execution of the selected event.

1-12. (canceled)

13. A method for event defining, voting, and funding for collaborative defining of, voting on, and funding of events, said method comprising the steps of:
providing an electronic system that permits the remote creation and carrying out of at least one event by means of an individual contribution and democratic, automatic and dynamic election of said event, said electronic system comprising at least one server, and at least one server interface accessible by at least one participant;
defining of a project on said server by an administrator of said electronic system;
registering of at least one event from said project, said event being added to said project for vote and execution;
accessing said server by said participant using said server interface;
checking of said registered event by said participant using said server interface;
selecting of said event by said participant using said server interface;
voting on said selected event by said participant using said server interface;
checking of said selected event by said participant using said server interface, said step of checking said selected vent allows said participant to follow the progress of said project of said server;
executing said selected event; and
checking the execution of said selected event.

14. The method as set forth in claim 12, wherein said server interface is plain old telephone services (POTS) having a Voice Portal using a technology called URA Unity of Audible Answer.

15. The method as set forth in claim 12, wherein said server interface is a device adapted to send electronic messages.

16. The method as set forth in claim 12, wherein said server interface is a wireless Internet device.

17. The method as set forth in claim 12, wherein said server interface is a computer accessing the Internet.

18. The method as set forth in claim 12 further comprising the step of, after said step of voting on said selected event, contributing a payment by said participant toward said vote using said server interface.

19. The method as set forth in claim 18 further comprising the step of, after said step of contributing a payment, generating an identification number by said server, said identification number corresponds to said payment contributing by said participant.

20. The method as set forth in claim 19 further comprising the step of, after said step of voting on said selected event, sending a confirmation message to said participant from said server through said server interface.

21. The method as set forth in claim 20 further comprising the step of, after said step of contributing a payment, send a second confirmation message containing said identification number to said participant from said server through said server interface.

22. The method as set forth in claim 12, wherein said step of defining of a project further comprising the steps of defining informations, rules and characteristics of said project.

23. The method as set forth in claim 22, wherein said step of registering of at least one event further comprising a register which consists in obtaining suggestions of said participant, validating said suggestions, and making them available for vote and subsequent execution.

24. The method as set forth in claim 23, wherein said step of checking of said registered event further comprising the checking by said participant said suggestions, which of said suggestions were validated, and the availability of said event.

25. The method as set forth in claim 24 further comprising the step of, after said registering of at least on event, releasing a list having event options, said list being released by said server.

26. The method as set forth in claim 25, wherein said step of voting on said selected event is confined by said rules defined in step of defining of a project.

27. A method for event defining, voting, and funding for collaborative defining of, voting on, and funding of events, said method comprising the steps of:
providing an electronic system that permits the remote creation and carrying out of at least one event by means of an individual contribution and democratic, automatic and dynamic election of said event, said electronic system comprising at least one server, and at least one server interface accessible by at least one participant;
defining of a project on said server by an administrator of said electronic system, said step of defining of a project comprising the steps of defining a type of events, defining rules of said project, providing characteristic of said project, defining forms of payment contributions, defining indicators of checking, defining indicators of attendance, and defining media of interaction;
providing a register events by said server from said project, said register of events comprising the steps of collecting suggestions from said participant, validating said suggestions, determining the availability of said validated suggestions, wherein said collecting of suggestions said participant suggests which event is to be executed through said server interface;
informing said participants, through said server interface, of a list of events that can be chosen;
checking of said register of events by said server, said step of checking of register of events comprising the steps of processing data obtained in said register of events so said data are organized in accordance to said indicators defined in said step of defining indicators of checking, and making available said indicators so that said participant can follow the progress of said register of events with a premiere of a cost of said events;
selecting of an event by said participant using said server interface from said register of events; said step of selecting of an event comprising the steps of choosing by said participant which of said events of a determined type of event said participant wants to contribute to, confirming by said server said chosen event, and transmitting to said participant from said server a receipt of vote;
checking of said chosen event by said server, said step of checking of said chosen event comprising the steps of processing data obtained in said step of selecting of an event so said data are organized in accordance to said indicators of attendance, and making available said processed data so that said participant can follow the progress of said chosen event;
executing said chosen event by said electronic system, said step of executing said chosen event comprising the steps of notifying said participant through said server interface of the execution of said chosen step, and executing said event chosen in said step of selecting of an event; and
checking of the execution of said event by said participant through said server interface;
wherein each of said suggestions is validated according to said definition of type of event as well as said rules of said project;
wherein after said suggestion is validated a contribution will be collected from said participant so that said suggestion becomes a susceptible event of being executed.

28. The method as set forth in claim 27, wherein said server interface is plain old telephone services (POTS) having a Voice Portal using a technology called URA Unity of Audible Answer.

29. The method as set forth in claim 27, wherein said server interface is a device adapted to send electronic messages.

30. The method as set forth in claim 27, wherein said server interface is a wireless Internet device.

31. The method as set forth in claim 27, wherein said server interface is a computer accessing the Internet.

32. An event defining, voting, and funding system comprising:
at least one server having at least one computer readable program, said program having a definition of project module, a register of events module, a checking of register of events module, a selection of events module, a checking of selection of event module, an execution module, and a checking of the execution module; and
at least one server interface device being in communication with said server.
